(19) United States
(12) Patent Application Publication
(10) Pub. No.: US 2010/0196564 A1
(43) Pub. Date: Aug. 5, 2010

(54) DEVICE FOR MANUFACTURING FILLED AND UNFILLED FOOD PRODUCTS

(76) Inventors: JOSE ABEL CEPEDA MENDOZA, San Mateo Antenco (MX); ESPIRIDION VALDES RODRIGUEZ, Toluca (MX)

Correspondence Address: FISH & RICHARDSON P.C., P.O. BOX 1022, MINNEAPOLIS, MN, 55440-1022, US

(21) Appl. No.: 12/504,499

(22) Filed: Jul. 16, 2009

(30) Foreign Application Priority Data
Feb. 3, 2009 (MX) MX/A/2009/001270
Feb. 3, 2009 (MX) MX/E/2009/007235

(51) Int. Cl. A21C 9/08; A21C 3/02; A21D 8/00

(52) U.S. Cl. 426/297; 425/101; 425/296; 426/502

(57) ABSTRACT

A device for manufacturing food products includes two or more raw material-feed hoppers, the hoppers being disposed above a conveyer belt and each hopper containing two rollers that rotate in opposing directions relative to one another to produce raw material sheets. A molding roller is disposed above the conveyer belt that rotates in a direction opposite of the conveyer belt. The sheets produced in the hoppers are deposited on the conveyer belt and are fed between the conveyer belt and the molding roller.

### CLAIM OF PRIORITY

Under 35 U.S.C. §119, this application claims the benefit of a foreign priority application filed in Mexico, serial number MX/a/2009/001270, also known as MX/E/2009/007235, filed Feb. 3, 2009, the entire contents of which are hereby incorporated by reference.

### TECHNICAL FIELD

The present disclosure relates to a device for manufacturing filled and unfilled food products.

### BACKGROUND

Within the food industry, especially in the industry manufacturing appetizers and fried snacks, several production methods and techniques have been developed for manufacturing products that are not only favorable regarding their taste, but also pleasing to the eye, with the aim of catching consumers' attention.

A variety of original grocery products have been introduced that have not only improved taste and nutritional features, but also improved shape and appearance. Within this market, and specifically in the market concerning appetizers and fried snacks, several products have been launched in an attempt to gain market position by means of new flavors, new shapes, and new advertising campaigns.

### SUMMARY

Accordingly, it is necessary to create production systems and machines that can manufacture food products of any kind (especially appetizers and fried snacks) that have shapes that are both aesthetically pleasing and original. These designs may provide a competitive advantage over products already positioned in the market.

Enterprises within this industry have developed a number of these products; however, most of them are “flat products” such as fried snacks made of cornmeal, potato flour, or wheat flour. These products generally have simple shapes such as circles, squares, triangles, and the like. The products are made by rolling a sheet of raw material with which the finished product is made with a mold that cuts the sheet. This process produces flat figures with the same thickness as the sheet and with a shape determined by the mold.

On the other hand, three-dimensional food products (e.g., products that are not “flat”) developed in the market use a complicated and consequently expensive production process, and this prevents these manufactured products from being competitive in the market.

As a result, a new production machine and system have been developed which enable the manufacturing of food products in three dimensions. Due to their simplicity, this production machine and system enables the manufacturing of such products in a low cost, efficient manner, and the products can contain particular features. These benefits provide the products with a competitive advantage when facing products already positioned in the market.

In some aspects, the methods and devices disclosed herein relate to the design and creation of a machine to manufacture food products, especially appetizers and fried snacks, in three-dimensional shapes. Furthermore, the design and creation of a machine is disclosed that, in spite of the simplicity of its design, operates in a particularly efficient manner for the production and manufacturing of food products, especially appetizers and fried snacks with three-dimensional shapes. Finally, in some aspects, the methods and devices disclosed herein relate to the creation of a production process that allows for the manufacture of three-dimensional food products.

This disclosure makes reference to a cutting process and machine for manufacturing food products in three dimensions, which includes at least two raw material-feed hoppers. Inside each of these hoppers there are two rollers that spin opposite relative to one another to produce sheets. The sheets are placed on a conveyor belt which transports the sheets to a molding roller placed on the conveyor belt. The molding roller spins in a direction opposite to the direction of the conveyor belt, and expels the recently cut three-dimensional products.

### DRAWINGS

FIGS. 1, 2, and 4 are schematic views of a food product manufacturing machine.

FIG. 3 is an example of material sheets produced by a food product manufacturing machine.

FIG. 5 is an example of filled material sheets produced by a food product manufacturing machine.

Like reference symbols in the various drawings indicate like elements.

### DETAILED DESCRIPTION

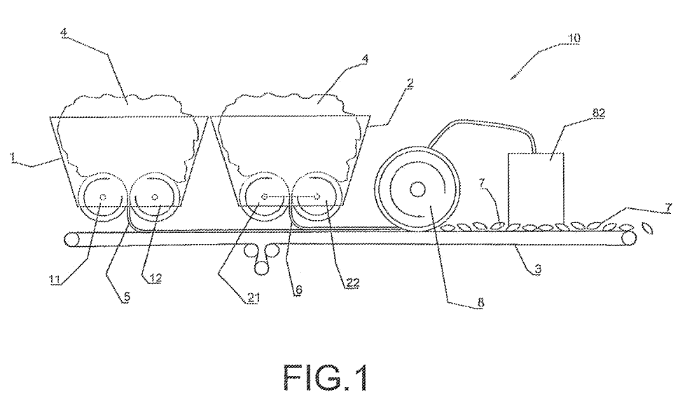

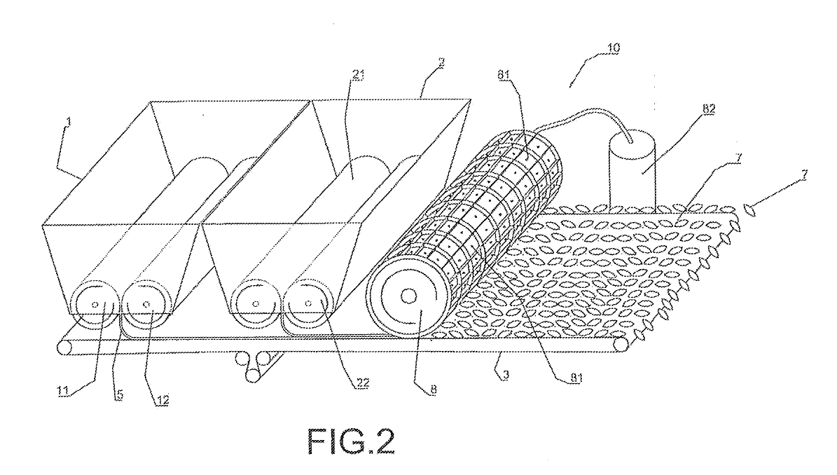

In the examples of FIGS. 1 and 2, machine 10 and the manufacturing process allow for the manufacture of food products 7, which have non-planar, three-dimensional configurations. In some examples, in the manufacturing process, raw material 4 is prepared in a stage previous to entering the machine. Such raw material 4 could be prepared with cereals such as corn, wheat, or any other cereal which may allow for the preparation of an even dough that could be cooked, baked, or fried before its subsequent consumption.

A hopper 1 is disposed proximate to and in series with hopper 2, both hopper 1 and hopper 2 being positioned in series above conveyor 3 having a longitudinal direction of travel. A portion of raw material 4 is inserted into hopper 1 and is put through rollers 11 and 12, which spin in directions opposite from one another. Rollers 11 and 12 are positioned at such a distance one from each other such that, by means of raw material 4, they allow for the preparation of a uniform planar dough sheet 5 with a thickness set by a gap established between the rollers. The remaining portion of raw material 4 is inserted into hopper 2 and is put through rollers 21 and 22, which spin in directions opposite from one another. Rollers 21 and 22 are positioned to such a distance from one another such that, by means of raw material 4, they allow for the preparation of an even planar dough sheet 6 with a thickness set by the gap established between the rollers.

While sheet 5 (which comes from hopper 1) is being made, sheet 5 is deposited on conveyor belt 3 leading to the following production process stage. Once planar dough sheet 6, which comes from hopper 2, is made, it is deposited on top of sheet 5, which had been previously placed on conveyor belt 3 to form a composite two layer planar dough sheet 70. In some examples, hoppers 1 and 2 are placed in close proximity to one another on conveyor belt 3 such that when sheets 5 and 6 are made, they can be transported on conveyor belt 3 to the following production stage including but not limited to baking, frying and cooking. Alternatively, the material in hopper 2 may be different from the material in hopper 1.

Sheet 6 is deposited on sheet 5 to form a sandwich two layer planar sheet 70 which is transported on conveyor belt 3 to the following production stage. Once sheets 5 and 6 have been combined and placed on conveyor belt 3, the composite two layer planar sheet 70 is put through a cylindrical molding roller 8. Molding roller 8 can be made in such a way that it cuts sheets 5 and 6 according to shapes that have been previously established and designed. Molding roller 8 is positioned in close proximity to the surface of conveyer belt 3, and spins in the opposite direction of conveyor belt 3. This arrangement allows composite two layer sheet 70 to be cut, creating three dimensional non-planar FIGS. 7. Molding roller 8 has multiple molding compartments 80 disposed on the exterior surface of cylindrical roller 8. Each compartment 80 may have a non-planar bottom surface with opening 81 located centrally in each one of the molding compartments.

Through the center of cylindrical molding roller 8, air is inserted by means of compressor 82; the air comes out of openings 81, causing the non-planar cut section 7 of the composite sheet 70, constituted by sheets 5 and 6, to be expelled out of molding roller 8 and drop on conveyor belt 3 leading to additional production processing.

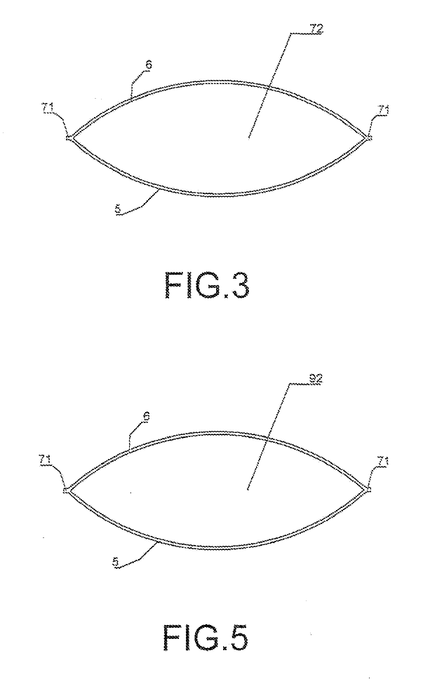

Non-planar cut FIG. 7 has been formed by parts of sheets 5 and 6, which are superimposed one onto the other; and by roller force imposed on the composite sheet 70, these sheets 5 and 6 may be cut from an upper surface entirely through to a lower surface by molding roller 8. The force exerted during the cutting process by means of molding roller 8 allows the perimeter 71 of non-planar cut FIG. 7 to be fused, leaving air volume 72 between both sheets 5 and 6 (see FIG. 3).

Once non-planar cut FIG. 7 has been cooked, baked or fried, air volume 72 enables such figure to be expanded and to be shaped into a predefined three-dimensional figure.

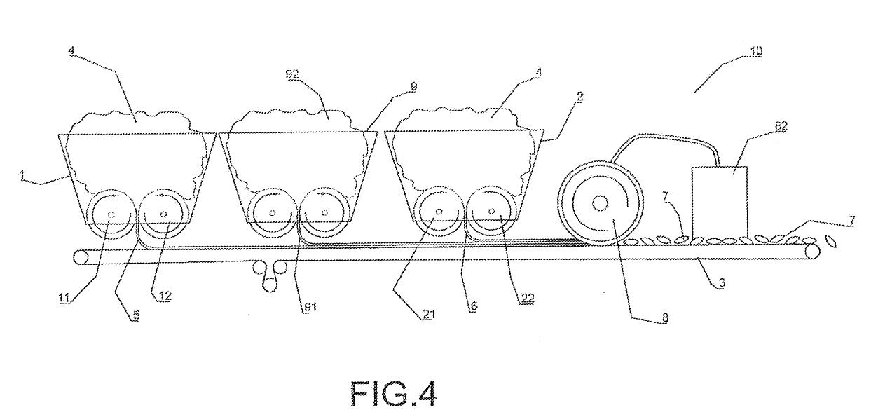

In some examples, such as the example illustrated by FIG. 4, machine 10 has two hoppers 1 and 2, as well as a third hopper 9, by means of which sheet 91 is produced along with a filling product to be placed between sheets 5 and 6 to form a composite three layer planar sheet 80. Such a process enables the manufacturing of filled non-planar products 82 (see FIG. 5).

The examples described and illustrated herein should be considered in a wide and non-restrictive sense, especially under the consideration that changes and modifications can be suggested without departing from the nature and field of the techniques described herein. Changes are expected to be part of the techniques described herein, especially if the changes fall within the scope of the following claims.

What is claimed is:

1. A device for manufacturing food products having three dimensions, the device comprising:
a transportation conveyor having a longitudinal direction of travel;
a first material-feed hopper disposed above the transportation conveyor, said first hopper including:
at least two parallel cylindrical rollers that rotate in opposite directions from one another, said rollers disposed transverse to the direction of travel of the transportation conveyor and proximate to the lower outlet of the hopper, said rollers spaced a predetermined distance apart and adapted to press a dough mixture into a first planar dough sheet and expel said first dough sheet from between the rollers and onto the transportation conveyor;
a second material-feed hopper disposed above the transportation conveyor, said second hopper including:
at least two parallel cylindrical rollers that rotate in opposite directions from one another, said rollers disposed transverse to the direction of travel of the transportation conveyor and proximate to the lower outlet of the hopper, said rollers spaced a predetermined distance apart and adapted to press a dough mixture into a second planar dough sheet and expel said second dough sheet from between the rollers and onto the first dough sheet being transported on the transportation conveyor, wherein said first and second dough sheet form a two layer composite planar dough sheet; and
a cylindrical molding roller having its central axis disposed transverse to the longitudinal direction of the transportation conveyor and rotatable about said central axis in a direction opposite the longitudinal direction of travel of the transportation conveyor, said roller disposed above and proximate to the transportation conveyor, said molding roller having a plurality of molding compartments disposed on an outer surface of the roller, said compartments adapted to contact the composite planar dough sheet and cut through the first and second layers thereof, thereby forming a plurality of three dimensional food products.

2. The device of claim 1, wherein each molding compartment of the cylindrical molding roller has an opening in an interior surface of the molding compartment connected to an interior chamber of the cylindrical molding roller.

3. The device of claim 2, wherein the cylindrical molding roller is adapted to receive pressurized air into the interior chamber of the molding roller, the pressurized air being expelled through the opening in each the of the molding compartments and thereby expelling the three dimensional food products from the molding compartment.

4. The device of claim 1, wherein the cylindrical molding roller is adapted to seal the perimeters of the first and second dough sheets of the composite dough sheet by a force exerted by the molding roller on the composition dough sheet.

5. The device of claim 1 wherein the interior surface of the molding compartment is non-planar and thereby forms a non-planar three dimensional food product in the molding compartment.

6. The device of claim 1, wherein a distance between each of the rollers in a pair of cooperating rollers determines a thickness of the dough sheet expelled from the rollers.

7. The device of claim 1, wherein a surface of the molding roller comprises cutting elements.

8. The device of claim 1, wherein a third hopper is disposed in series between the first and second hopper, said intermediate hopper containing a filling that is deposited on an upper surface of the first dough sheet before the second dough sheet is placed onto the first dough sheet.

9. The device of claim 1, wherein at least one additional material hopper is disposed in series between the first and second hoppers, said additional hopper disposed above the transportation conveyor, said additional hopper including:
at least two parallel cylindrical rollers that rotate in opposite directions from one another, said rollers disposed transverse to the direction of travel of the transportation conveyor and proximate to the lower outlet of the hopper, said rollers spaced a predetermined distance apart and adapted to press a dough mixture into an intermediate dough sheet and expel said intermediate dough sheet from between the rollers onto the first dough sheet being transported on the transportation conveyor, wherein said first and intermediate and second dough sheet form a multi-layer composite planar dough sheet.

10. The device of claim 9, wherein each molding compartment of the cylindrical molding roller has an opening in an interior surface of the molding compartment connected to an interior chamber of the cylindrical molding roller.

11. The device of claim 10, wherein the cylindrical molding roller is adapted to receive pressurized air into the interior chamber of the cylindrical molding roller, the pressurized air being expelled through the opening in the interior of each of the molding compartments and thereby expelling the three dimensional food products from the molding compartment.

12. The device of claim 9, wherein the cylindrical molding roller is adapted to seal the perimeters of the first and second dough sheets of the composite dough sheet by a force exerted by the molding roller on the composite dough sheet.

13. The device of claim 9, wherein the interior surface of the molding compartment is non-planar and thereby forms a non planar three dimensional food product in the molding compartment.

14. The device of claim 9, wherein a distance between each of the rollers in a pair of cooperating rollers determines a thickness of the dough sheet expelled from the rollers.

15. The device of claim 9, wherein a surface of the molding roller comprises cutting elements.

16. The device of claim 9, wherein a third hopper is disposed in series between the first and second hopper, said intermediate hopper containing a filling that is deposited on a upper surface of the first dough sheet before the second dough sheet is placed onto the first dough layer.

17. A method for manufacturing a food product having a three-dimensional shape, the method comprising:
superimposing a first planar dough sheet onto a second planar dough sheet to form a composite planar sheet;
contacting the composite planar dough sheet with a cylindrical molding roller having a plurality of compartments disposed on the surface of the cylindrical molding roller;
joining by force exerted by the cylindrical molding roller the perimeter of both sheets of the composite planar dough sheet;
cutting through both layers of the composite sheet by force exerted by the molding roller on the composite sheet to form individual three dimensional food products;
expelling onto a transportation conveyor the individual three dimensional food product from each molding compartment using compressed air passing from an interior chamber of the molding roller though an opening in an interior surface of the molding compartment;
transporting said food product on the conveyor for further processing.

18. A method for manufacturing a food product having a three-dimensional shape, the method comprising:
forming a first dough sheet and depositing it on a transportation conveyor;
forming a second dough sheet and depositing it on top of the first dough sheet on the transportation conveyor to form a composite sheet;
contacting the composite dough sheet with a molding roller having a plurality of compartments disposed on the surface of the molding roller;
joining by force exerted by the molding roller the perimeter of both sheets of the composite dough;
cutting through both layers of the composite sheet by force exerted by the molding roller on the composite sheet to form individual three dimensional food products;
expelling onto a transportation conveyor said individual three dimensional food product from the molding compartment using compressed air passing from an interior chamber of the molding roller though an opening in an interior surface of the molding compartment;
transporting said food product on the conveyor for further processing.

19. The method of claim 18 further including depositing a filling on the top surface of the first dough sheet on the transportation conveyor before the second dough sheet is disposed on top of the first dough sheet.

20. The method of claim 18 further including forming an intermediate dough sheet and depositing it on top of the first dough sheet on the transportation conveyor before depositing the second dough sheet on top of the intermediate dough sheet.
